(19) United States
(12) Patent Application Publication
(10) Pub. No.: US 2017/0045902 A1
(43) Pub. Date: Feb. 16, 2017

(54) CONTROL STRATEGIES FOR GRID SCALE STORAGE OPERATION IN FREQUENCY REGULATION MARKETS CONSIDERING BATTERY HEALTH FACTORS

(71) Applicant: NEC Laboratories America, Inc., Princeton, NJ (US)

(72) Inventors: Rakesh PATIL, SAN FRANCISCO, CA (US); Parth PRADHAN, BETHLEHEM, PA (US); Ratnesh SHARMA, FREMONT, CA (US)

(21) Appl. No.: 15/237,590

(22) Filed: Aug. 15, 2016

Related U.S. Application Data
(60) Provisional application No. 62/205,262, filed on Aug. 14, 2015.

(51) Int. Cl. G05F 1/66; G05B 13/04; G05B 13/02; G05B 19/042

(52) U.S. Cl. CPC G05F 1/66; G05B 19/042; G05B 13/048; G05B 13/0265; G05B 2219/40458

(57) ABSTRACT

Aspects of the present disclosure relate to methods and systems for improved energy storage systems employing batteries operating in a frequency regulation market.

### CROSS REFERENCE TO RELATED APPLICATIONS

This application claims the benefit of U.S. Provisional Patent Application Ser. No. 62/205,262 filed Aug. 15, 2015 the entire contents of which are incorporated by reference as if set forth at length herein.

### TECHNICAL FIELD

This disclosure relates generally to energy storage methods and systems. More particularly, this disclosure relates to methods and systems for operating in a frequency regulation market.

### BACKGROUND

Recently, as Grid Scale Storage (GSS) systems participating in the frequency regulation market maximizes its revenue by tracking an Automatic Generation Control (AGC) signal sent by a System Operator (SO). Traditionally, the resources participating in this market were paid only on the basis of the generation capacity that they can provide and not on the performance of the actual electricity delivered. However, after the introduction of pay for performance scheme by the Federal Electricity Regulation Commission (FERC), there is an incentive for the GSS providers to improve accuracy of the signal following AGC signals. The system operators are implementing this order by designing different schemes of performance evaluation processes.

Accordingly, given its emerging importance to frequency regulation markets, methods and structures that enhance their performance with respect to fast frequency regulation would represent a welcome addition to the art.

### SUMMARY

An advance in the art is made according to the present disclosure which describes methods and structures for improved battery energy storage systems—and in particular control strategies to operate battery(ies) in response to an AGC signal in a manner that accounts for battery degradation factors, while maximizing the revenues from participating in frequency regulation (FR) ISO market(s).

Advantageously, systems and methods according to the present disclosure define a degradation cost and include that negative cost into a revenue maximization problem. The degradation cost accounts for battery degradation factors such as energy throughput—which is the total amount of energy into and out of the battery and or deviation from a reference SoC.

In sharp contrast to prior art systems, by implementing control strategies that account for instantaneous battery degradation factors in the battery system—methods and systems according to the present disclosure dramatically improve the battery life of systems in FR markets. Of particular interest, measurable commercial value namely increased revenues over battery life cycle for GSS owners and guaranteed performance are but two advantages of systems and methods according to aspects of the present disclosure.

Finally, and of further advantage, and as will be shown and quantified, method(s) and structures according to the present disclosure produce significant performance improvements in while reducing cost of operation.

### BRIEF DESCRIPTION OF THE DRAWING

A more complete understanding of the present disclosure may be realized by reference to the accompanying drawing in which:

FIG. 1 is a schematic diagram illustrating Grid Scale Storage (GSS) relationship to overall electrical generation/distribution/utilization network according to the present disclosure;

FIG. 2 is a schematic diagram illustrating a representative operation of GSS in response to AGC signal according to an aspect of the present disclosure;

FIG. 3 is a schematic diagram illustrating a number of market factors influencing GSS response and configuration according to an aspect of the present disclosure;

FIG. 4 is a schematic diagram illustrating a modified control strategy devised using FR market prices according to an aspect of the present disclosure.

FIG. 5 is a schematic diagram illustrating extra information utilized by the control strategy to devise a modified command for GSS response according to the present disclosure;

FIG. 6 is a plot showing average instantaneous performance factor vs instantaneous energy throughput based degradation factor for 3 random days;

FIG. 7 shows an example of how response signal(s) behave when the weight on instantaneous degradation is 0.7;

FIG. 8 is a graph showing trade-off points obtained under different control strategies in Day 1;

FIGS. 9(A) and 9(B) are plots wherein FIG. 9(A) compares the trajectories of response signals under current and proposed control strategies and FIG. 9(B) compares difference in the optimal response signals when different dₐᵥs are desired;

FIG. 10 is a plot of a trade-off curve obtained using periodic bi-level (High, Low) hourly market price structure(s);

FIG. 11 is a plot showing that the performance factor stays above 0.7 cost even during low market price hour and under reasonable weight to degradation cost in a four hour time horizon;

FIG. 12 is a plot showing an optimal response signal that tracks AGC signal better during low price period;

FIG. 13 is a plot of a trade-off curve;

FIG. 14 is a plot showing trade-off curve

FIG. 15 is a plot showing trade-off curve and SoC and response signal trajectories.

The illustrative embodiments are described more fully by the Figures and detailed description. Inventions according to this disclosure may, however, be embodied in various forms and are not limited to specific or illustrative embodiments described in the Figures and detailed description

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the FIGs comprising the drawing are not drawn to scale.

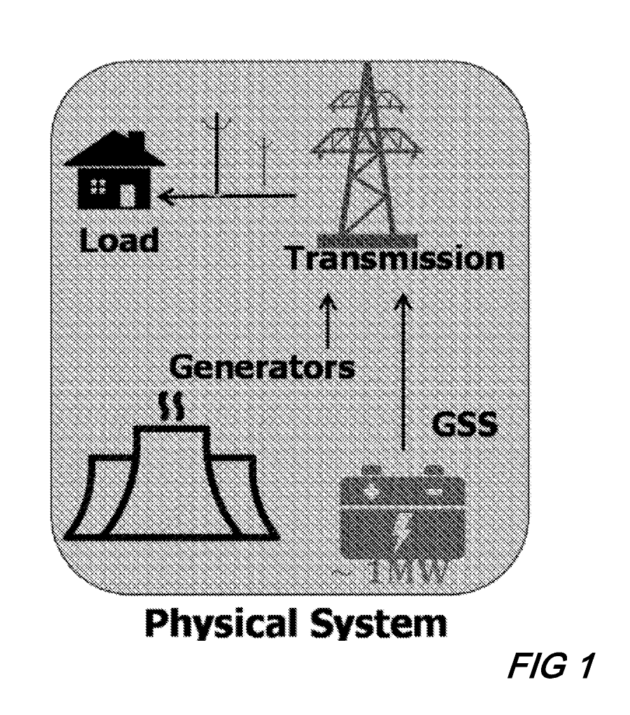

FIG. 1 is a schematic diagram depicting where the GSS fits into an overall electrical distribution network. As may be readily observed from that figure, the GSS is interconnected to the overall electricity generation, distribution, utilization network grid at a location where it may participate in the FR ISO market(s).

We begin by noting that in a series of papers by B. Xu, A. Oudalov, J. Poland, A. Ulbig, G Andersson entitled “BESS Control Strategies for Participating in Grid Frequency Regulation” presented at the World Congress, Vol. 19, No. 1, 2014; J. Donadee, M. Ilic entitled “Estimating the rate of battery degradation under a stationary Markov operating policy” presented at PESA General Meeting, Conference and Exposition, 2014 IEEE, Vol., no., pp. 1, 5, 27-31, Jul. 2014; and F. Matthey, T. Kamijoh, K. Takeda, S. Ando, T. Nomura, T. Shibata, A. Honazowa entitled “Cost benefit analysis tool and control strategy selection for lithium-ion energy storage system” presented at PES general meeting, conference and exposition, 2015 IEEE, the issues associated with degradation of batteries participating in frequency regulation have been narrowly addressed. More particularly, the evaluation of battery degradation and practical control strategies for market participation have been explored but several assumptions such as a zero-mean AGC signal were made that may not always be the case. In addition, these papers do not analyze any tradeoffs between degradation and market revenues making it challenging to devise any control strategies from their disclosures. Others, see, e.g., A. Hoke, et. al., “Electric vehicle charge optimization including effects of lithium-ion battery degradation” Vehicle Power and Propulsion Conference (VPCC), 2011 IEEE, vol., no., pp/1, 8, 6-9 Sep. 2011, propose a control strategy of intentionally deviation from the regulation signal to achieve higher long term profit although they do not guarantee any performance through optimization. Moreover, the proposed strategy therein does not account for daily difference(s) in AGC signal and the multitude of battery degradation factors. Stated alternatively, any insight on how good or bad the control strategy is that considers instantaneous degradation while following AGC signal is also limited as there is no optimization problem solved to answer it.

Worth noting further, renewable energy grid integration with storage and electric vehicle battery management are two other areas where improvement in battery life from adopting optimal control strategy have found value. This further motivates the need for systems and methods according to the present disclosure to directly account for battery degradation in devising any control strategy for frequency regulation.

Generally, GSS providers simply charge the battery when the AGC signal is negative and discharge the battery when it is positive with no consideration given for long term battery health. The command is responded to in matter of seconds. Energy injection into the grid and withdrawal from the grid is accomplished with the help of DC-AC and AC-DC power converter respectively.

Other recent publications on GSS serving regulation needs have been made towards increasing its efficiency. More particularly, disclosures with respect to using battery system as a back-up electricity supply for frequency services, a battery management system that stabilizes the frequency in the power distribution network, and monitoring the SoC level and offsets the deviation from a reference SoC at the end of the operating period as a corrective measure to improve battery health, have been made. Other(s), describe reduction in negative battery health but do not propose or disclose control strategies to maximize revenue or consider other degradation factors such as Eₜₕ.

As we shall show and describe, according to an aspect of the present disclosure we solve the above problems by defining a degradation cost and including that negative cost in the revenue maximization problem. The degradation cost accounts for battery degradation factors such as energy throughput Eₜₕ which is the amount of total energy in an out of the battery and/or deviation from a reference SoC. We compare the response signals in the cases with different degree of weights or importance given to the degradation costs with the response signals in the case when degradation cost is not considered. Through this comparison, we synthesize implementable control strategies to generate the battery response that take into account battery degradation or battery health. In sharp contrast to the prior art, we compare different optimal solutions and more importantly describe our synthesized control strategies to generate the response signal for batteries participating in the FR markets. By implementing the control strategy that accounts for instantaneous battery degradation factors in the battery system—the battery life is improved. Our approach advantageously provides a choice of strategies based on the desired life and net revenues from the battery. The specific commercial value is increased revenues over the battery life cycle for the GSS owner and guaranteed performance scores as calculated by the ISO.

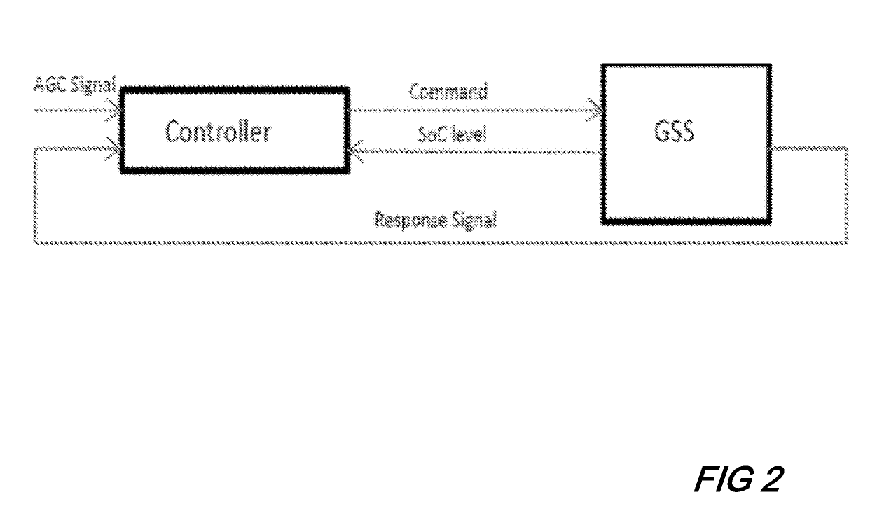

With reference to FIG. 2, we now describe the general operation of the GSS as follows. An AGC signal is provided as input to a GSS controller. GSS tracks the signal closely as long as its State of Charge (SoC) level stays within limits. The ISO assigns a performance score based on the accuracy of tracking signal. The payment is then made to the GSS provider shortly after its service depending on the performance and the market prices. Thus, an instantaneous reward is given all the importance without considering GSS degradation cost.

As will become apparent to those skilled in the art, our approach is a GSS control strategy that takes into account battery degradation while operating in the FR market. This is advantageously performed by assigning a cost to the degradation based on factors such as Energy throughput Eₜₕ, which is the total amount of energy in and out of the battery, and/or deviation from a reference SoC—both of which are crucial factors affecting battery health. For our purposes herein, GSS instantaneous reward is defined as a weighted sum of instantaneous performance based revenue and instantaneous degradation. The optimal solution maximizes this reward and is obtained using an optimal control method such as dynamic programming.

By so doing, the GSS controller gains more control over its degradation. The desired cost of degradation may be manipulated by changing the value of relative weight of degradation cost. A trade-off plot is then obtained between revenue and degradation by changing the weight over a range of values.

Based on the desired life of the battery, or the desired increase in revenues over a lifetime of the battery, we develop control rules by analyzing the optimal solutions to implement on the battery hardware. For example, when Eₜₕ is considered as the primary factor for degradation and only the performance is of interest (not the total revenues), we observe that a threshold level is established by the optimal solution above which the AGC signal is not followed. This threshold varies with the relative cost of the degradation and can be determined as follows.

To reduce average instantaneous degradation to “x”, the response signal should follow AGC signal as long as

$$\vert AGC \vert \leq \frac{{k}_{1} - \sqrt{{k}_{2} - {k}_{3} x}}{2 ( {k}_{4} - {k}_{1} + \sqrt{{k}_{2} - {k}_{3} x} )}$$

where k₁, k₂, k₃ and k₄ are constants obtained from a curve fitting the degradation as a function of known relative weight. Other control rules that supplement the above threshold and establish a complete control strategy are: 1) The degradation depends on the AGC signal for that particular day. Therefore, it is expected that the values of constants stay similar under similar AGCs for different days. 2) The threshold has the same sign (+ or −) as that of the AGC signal. 3) the expression of threshold value will change if the SoC level stays close to its limits.

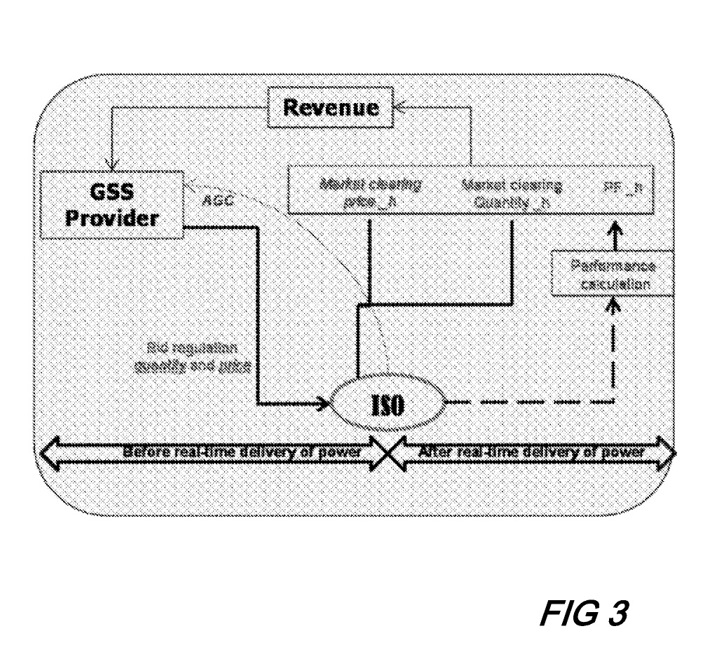

Another instance of this solution accounts for the actual revenue generated over the period of a day (or timeline of that order) when the market price for the services vary. For FR market participation, all resources are provided capacity revenue in order to commit for the next day and then an hourly (or 5 minute) market price signal pays for the actual response. This market clearing price is sometimes called mileage payment and is multiplied with the performance score to provide the revenue. These market factors are highlighted in FIG. 3.

As will be apparent to those skilled in the art, the results of the optimization problem after including these new features show that the GSS response signal now varies not only with the weight on degradation (i.e., the variable “x” in the equation above) but also as a function of the projected market clearing price ( [symbol] ). For example, the optima solution would seek to keep performance during high market prices and reduce the performance during low market prices to compensate for the degradation effects. In this case, if Eₜₕ is considered as the primary factor for degradation, then the control strategy would be similar to the above case but with a modification that accounts for [symbol] , namely:

$$\vert AGC \vert \leq \frac{{k}_{1} - \sqrt{{k}_{2} - {k}_{3} x}}{2 ( {k}_{4} - {k}_{1} + \sqrt{{k}_{2} - {k}_{3} x} )} f ( )$$

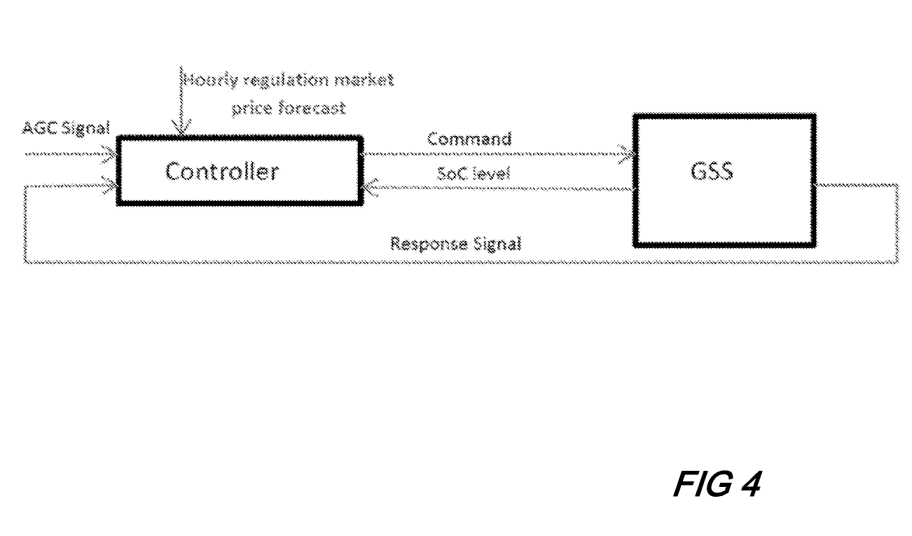

The modified control strategy is shown schematically in FIG. 4 as compared to the current strategy shown schematically in FIG. 2.

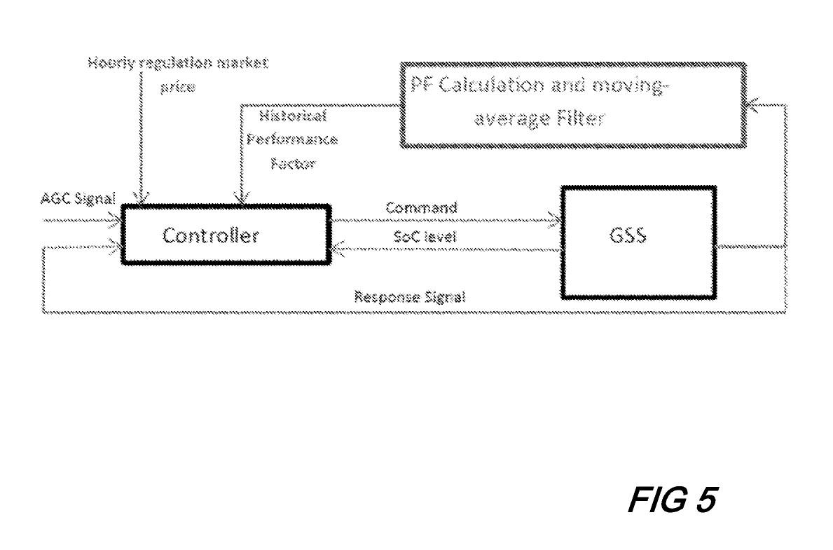

Yet another instance of a control strategy according to the present disclosure relates to maintaining a satisfactory performance score. Market regulations dictate minimum acceptable values for the performance score and to ensure steady long-term revenue because the ISO can disqualify a resource based on low performance scores. In the case that degradation cost is prioritized or the market clearing prices are low—the optimal decision may dictate low performances. In order to avoid such a condition, to maintain proper levels of the performance score we provide a feedback signal that captures the performance score and modifies the control strategy. This feedback is provided through a function that determines the performance factor of current response signal and a moving average filter block that takes the performance factor as an input and generates the historical performance score as shown in FIG. 5.

One advantage of a controller design according to the present disclosure is that the response signal modulates with price to control revenue and degradation but never lets the historical price drop below certain value(s). It now has a new threshold limit (similar to Eq. (1) and (2)) that changes with desired cost of degradation, market price and historical performance score.

Finally, it should be noted that the degradation factor considered in the above instances of our control strategy discussion consider only Energy throughput (Eₜₕ) as the factor influencing degradation. In parallel instances, a similar set of control strategies can be derived considering SoC deviation based degradation where the threshold limits for the response signal (as expressed in Eq. (1) and (2)) are obtained as threshold on the minimum and maximum allowed SoC values around a chosen reference SoC. The band of allowable SoC changes with the desired tradeoff between revenues and the impact of degradation and will be similar to Eq. (1) and (2) in their form.

Of further advantage, our disclosure is applicable to any FR ISO market where performance is related to how closely the signal is followed and the market prices are varying with time.

By way of some additional theoretical background, we note that grid scale storage (GSS) participating in a frequency regulation market maximizes its revenue by tracking an Automatic Generation Control (AGC) signal sent out by a System Operator (SO). Traditionally, the resources participating in this market were paid only on the basis of the generation capacity that they can provide and not on the performance of the actual amount of electricity delivered. However, after the introduction of pay for performance scheme by the Federal Electricity Regulation Commission (FERC), there is an incentive for GSS providers to improve the accuracy of the signal following AGC signals. System operators are quickly implementing the order by layout different ways of performance evaluation processes of the resource services. This is a welcome change for fast responding GSS providers who are steadily penetrating into this market.

Until now, there has been no methodology developed that convincingly answers the question namely, does reducing instantaneous energy—while following the AGC signal—provide higher accumulated revenue over the GSS operating life. The AGC signals are generated in a very short time scale which implies that accurately following it would lead to high energy exchange rate at all times during GSS regular operation. Now, all kinds of battery storage technologies have an operating life that depends on the conditions it is operated at. In this regard, degradation due to the operational practices of fast responding GSS has received little examination.

We now note that we will show there exists an optimal trade-off between GSS performance and degradation. This serves as a benchmark to compare different control strategies with different degrees of weights to the instantaneous degradation. Co-optimizing revenue and degradation brings more control over the GSS capacity degradation during its operation. We show that the market price as an input and history of actions as a feedback to a GSS controller improves the efficiency of the overall system in the long run Simple rules on system action can then be devised from the results of the optimization problem. More specifically, the trajectory of response signal tracking AGC signal can be regulated to provide desired revenue and increase in battery life.

Problem Formulation

Background

1) Performance Factor:

PJM's evaluates the performance of a resource by computing an hourly performance factor pfₕ which is defined as a weighted sum of the following three scores:
Correlation score=max_{(δ=0 to 5 Min)}σ_{Signal,Response}(δ,δ+5 Min) calculated every 10s where σ is a correlation function and δ is shifted time steps.

$$Delay score = \frac{δ - 5 Min}{5 Min} calculated every 10 s$$

$$Precision score - 1 \text{-} Abs [ \frac{\sum Abs ( {W}_{t} ) - \sum Abs ( {AGC}_{t} )}{\sum Abs ( {AGC}_{t} )} ]$$

Revenue: Resources once qualified to participate in the PJM frequency regulation market submit bids for power quantity and price (both capacity and mileage). The market is clearly for every hour in next day and hourly market prices αₕ are determined. In real-time, each market cleared resource is paid an amount adjusted by a performance factor evaluated by SO. Roughly, the hourly payment to a resource i can be described as:

r_{i,h}=αₕ×pf_{i,h}.

Market regulations dictate resources to maintain minimum acceptable values for the performance score because the ISO can disqualify a resource based on low performance scores. The past hourly performance values also impact its future bid selection process. This moving average is termed as historical performance score (pfₕ^{hs}).

DDP Framework

Under the assumption that daily AGC signal, AGCₜ, is known in advance, a GSS operator with battery capacity C maximizes total reward over T time horizon, i.e.,

$${max}_{{P}_{t}} {\sum }_{t}^{T} {R}_{t} ( {P}_{t} , {S}_{t} )$$

where Sₜ is the system state and Pₜ is the action or response signal. The GSS reward function, Rₜ at each time step t is a weighted sum of instantaneous revenue (rₜ) and degradation factor (dₜ) written as

Rₜ=λrₜ+(1−λ)dₜ,λε(0,1)

The state of charge SoCₜ constrained between limits 0 to 1 defines the physical dynamics of the GSS. Taking the inspiration from current market mechanisms and making following assumptions, we come up with three revenue models suitable under DPP formulation.
The time horizon, T, is chosen as 24 hours.
A unified time step t for all system variables are chosen as 10s.
The hourly performance score pfₕ is simplified to only precision score (modified but definition preserved) obtained every 10s defined as:

pfₜ=1−Abs[AGCₜ−Pₜ],tε(10,20, . . . ,86400)

where AGCₜ is interpolated to time step t. Note that the area under the response signal in 10s is energy in/out of GSS (otherwise defined as instantaneous energy throughput CtPₜ) The correlation and delay scores are eliminated to maintain causality of revenue variables (from GSS perspective, calculation correlation involves the prediction of its own action to decide current action). Even a correlation of two signals without delay is computationally expensive even for moderate size state cardinality.
Unlike PJM, pfₕ^{hs} that is an average of past 100 pfₕ the historical performance factor pfₕ^{hs} is a moving average of past few pfₜ only.
The dynamic market prices are also scaled down to 10s market prices uniform within an hour.

Degradation Functions:

Two types of instantaneous degradation functions (also degradation factors), dₜ are defined as follows:
Instantaneous normalized energy throughput based: |E|ₜ²
Instantaneous SoC level based:

$$\vert \frac{{SoC}_{t} - {SoC}_{ref}}{{SoC}_{ma x} - {SoC}_{ref}} \vert$$

Like performance factors, the value of a degradation factor also varies from 0 to 1.

System Models:

For each type of revenue model, sₜ and Rₜ are defined under Type I, II and III problem formulations as follows:

Sₜ=(SoCₜ,AGCₜ),Rₜ=λpfₜ+(1−λ)dₜ Type I:

Sₜ=(SoCₜ,AGCₜ,αₜ),Rₜ=λcαₜpfₜ+(1−λ)kdₜ Type II:

Sₜ=(SoCₜ,AGCₜ,αₜpfₜ^{hs}),Rₜ=λcαₜpfₜ+f(pfₜ^{hs},αₜ)kdₜ Type III:

In type II and III problem formulations, a cost of degradation, k, is scaled down version of cost of replacement, maintenance, etc. In the optimal problem formulation, SoC is discretized into 1000 values, response signal into 22 values and historical performance factor into 50 values.

Results and Discussion

We now provide our results from maximization of finite horizon GSS provider's net reward under different problem formulations. In particular, the revenue-degradation trade-off is analyzed and subjective assessment of the optimal action is discussed. A hypothesis on the structure of a Type I problem result is described which is then tested using a simulation case study.

One reason why a type I problem is discussed in detail is because its results can directly be compared to the results from current industry practices. Type II and III problem results substantiate our argument that there are key market factors whose information may help optimize net revenue from GSS. The nature of optimal action trajectory in those problems is more emphasized. The type IV problem results on trade-off and corresponding response signal are obtained using degradation as a function of instantaneous SoC level.

Type I Problem

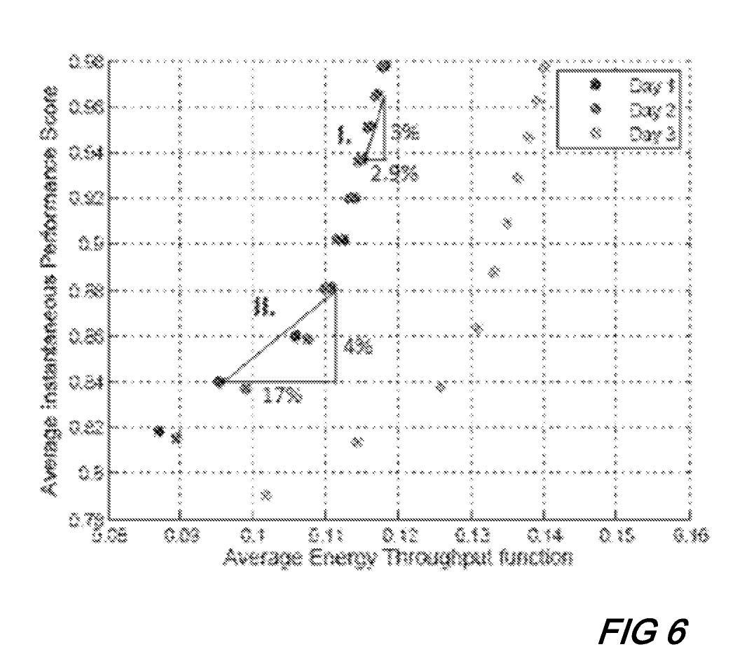

FIG. 6 is a plot showing average instantaneous performance factor vs instantaneous energy throughput based degradation factor for 3 random days. It may be observed that the trade-off is more pronounced in region II as compared to region I, suggesting instantaneous degradation reduction by losing performance factor(s) slightly may be economically beneficial in a long run. On the contrary, if the current performance factor is already high, any gain in battery life is disproportionally lower with a drop in performance factor.

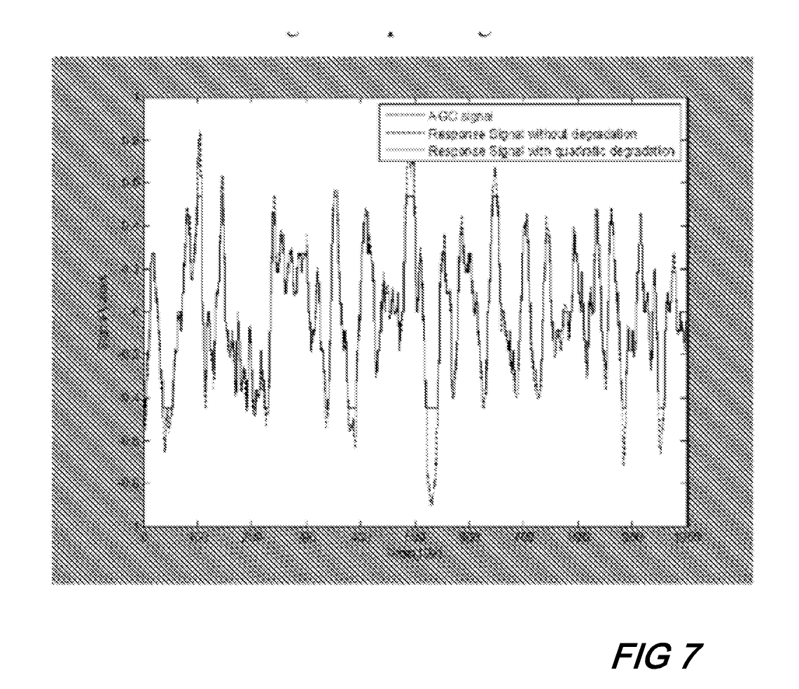

This characteristic of the trade-off can be attributed to the fact that the instantaneous energy in and out decreases as we put higher weight to the degradation compared to revenue. Therefore, response signal trajectories corresponding to increasing weights on degradation give increasing value of total energy throughput for the same AGC signal in a day. The response signal obtained from the optimization also exhibits that three is a cut-off value beyond which AGC signal need not be followed. FIG. 7 shows an example of how response signal(s) behave when the weight on instantaneous degradation is 0.7.

Based on these observations, we note the cut-off value or threshold of response signal is a function of average instantaneous degradation and therefore provide the following control rules:
1. To reduce the value of average degradation factor to “x”, the response signal should follow AGC signal as long as the following relationship is maintained:

$$\vert AGC \vert \leq \frac{{k}_{1} - \sqrt{{k}_{2} - {k}_{3} x}}{2 ( {k}_{4} - {k}_{1} + \sqrt{{k}_{2} - {k}_{3} x} )}$$

where k₁, k₂, k₃ and k₄ are constants obtained from a curve fitting the degradation as a function of known weight. The degradation depends on the AGC signal for that particular day. Therefore, it is expected that the values of constants stay similar under similar AGCs for different days.
2. The average instantaneous degradation should not be reduced beyond a certain value y. In the absence of this rule, the performance factor can run the risk of facing disqualification in the market.

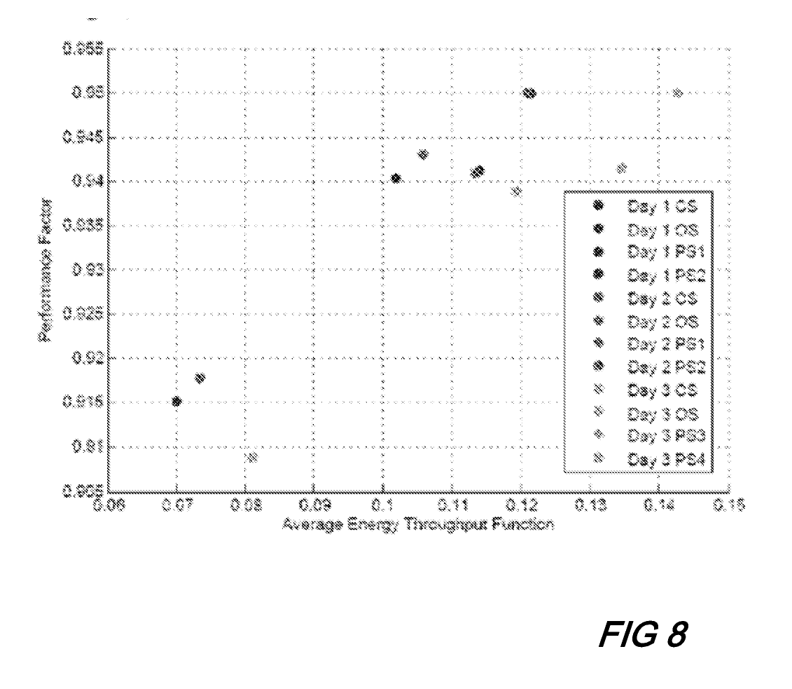

Notably, we can design simulation cases to verify the rules on GSS control stated above. Refer to FIG. 8 for the trade-off points obtained under different control strategies in Day 1.

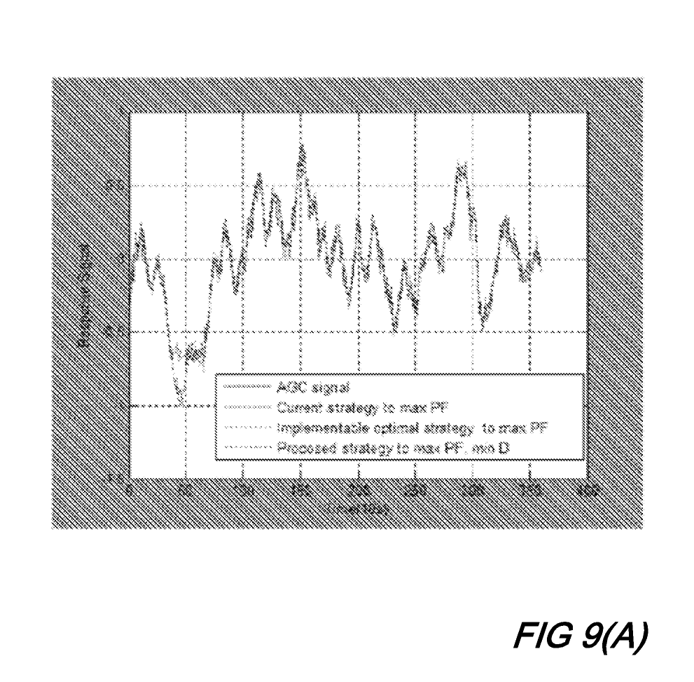

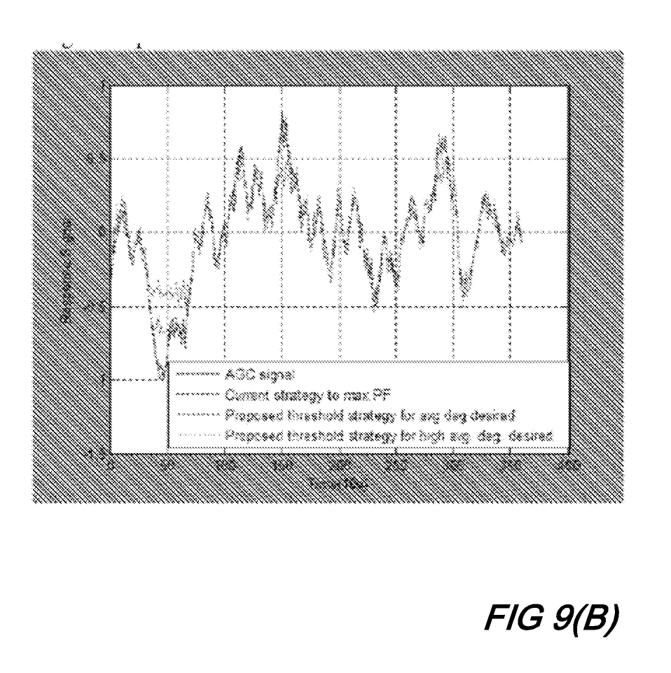

We let the current control strategy (CS) is assumed to achieve a pfₐᵥ of 0.94 and instantaneous dₐᵥ of 0.11 on a random day. Implementing our proposed control strategy (PS1) in which instantaneous dₐᵥ of 0.1 is desired, a response signal with cut-off value (sign of AGC₁) 0.66 needs to be followed. On doing this, the PF stays the same as current strategy. If further reduction of dₐᵥ is asked, another strategy (PS2) can be executed in which the response signal falls under tighter threshold limits substantially equal to ±0.41. On the other hand, improving control strategy to reach the maximum achievable pfₐᵥ=0.95 (if any such optimal strategy (OS) exists) does not offer much in terms of increase in average battery capacity. The evaluation of this kind of trade-off is illustrated for two other random days in FIG. 9(A) and FIG. 9(B). FIG. 9(A) compares the trajectories of response signals under current and proposed control strategies and FIG. 9(B) compares difference in the optimal response signals when different dₐᵥs are desired.

Type II Problem

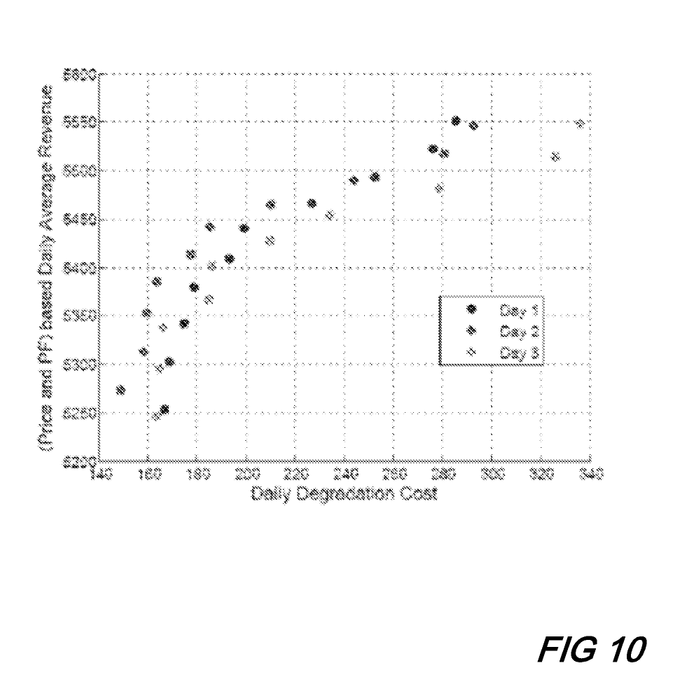

The trade-off curve shown in FIG. 10 is obtained using periodic bi-level (High, Low) hourly market price structure(s). As the revenue is a function of market price along with performance score, the trade-off curve is influenced by it. When the market prices are low, it is desirable to implement control strategy(ies) that reduce instantaneous cost of degradation dₐᵥ. In the curve, the points in the lower left region have higher effect of weight on degradation as hourly revenue is comparable to hourly cost of battery degradation. The opposite is observed when the market price is high which results in higher hourly revenue. Another observation is that the optimal response signal has a cut-off limit which varies linearly with market price and desired hourly cost of degradation. As such, a general conclusion can be made that when the hourly market price is high, the AGC signal should be followed as closely as possible and when market price is low, follow it as long as it is less than certain threshold value to obtain desired average cost of instantaneous degradation. Therefore, hourly market price is an important information that should be given as an input to the GSS controller. The trade-off curve shown in FIG. 10 is obtained using periodic bi-level (High, Low) hourly market price structure(s.

Type III Problem

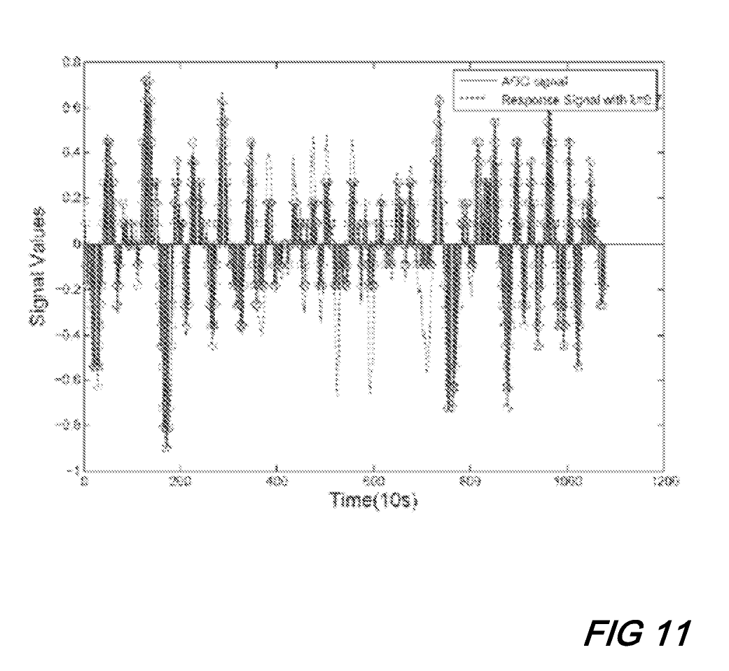

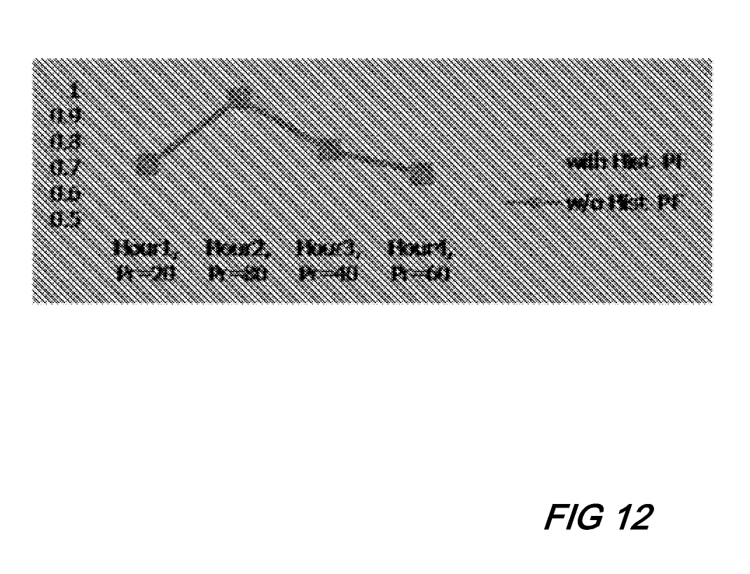

The results of type III show that control strategies may be developed to prevent the performance score dropping too low. They are compared against type II problem results under another market price structure. As illustrated in FIG. 11, the performance factor stays above 0.7 cost even during low market price hour and under reasonable weight to degradation cost in a four hour time horizon. The optimal response signal as shown in FIG. 12 tracks AGC signal better during low price period as compared to its counterpart from type II problem solution and yet achieves the same overall reduction in the cost of battery degradation. Results from this simple problem formulation is sufficient to conclude that a rule on response signal may be developed based on certain values of historical performance score, SoC values and market prices.

Type IV Problem

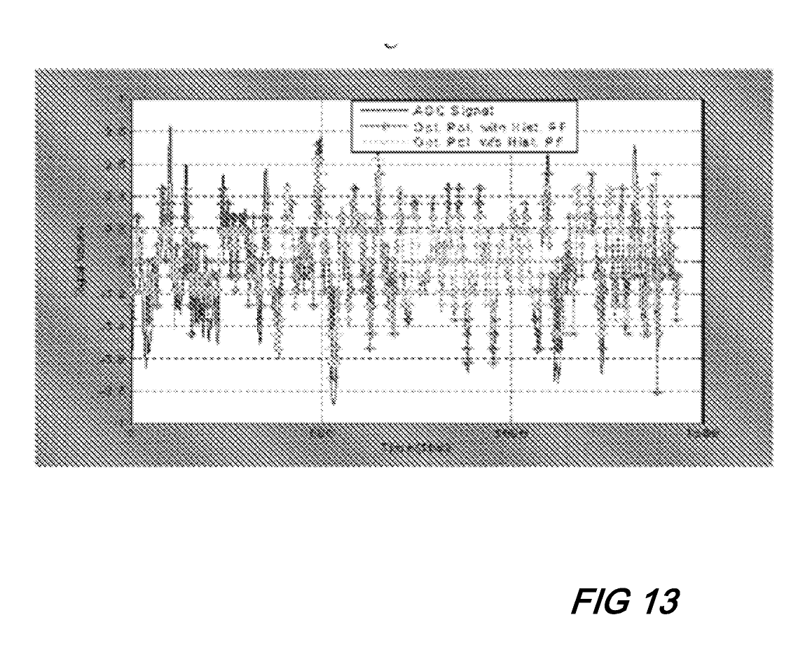

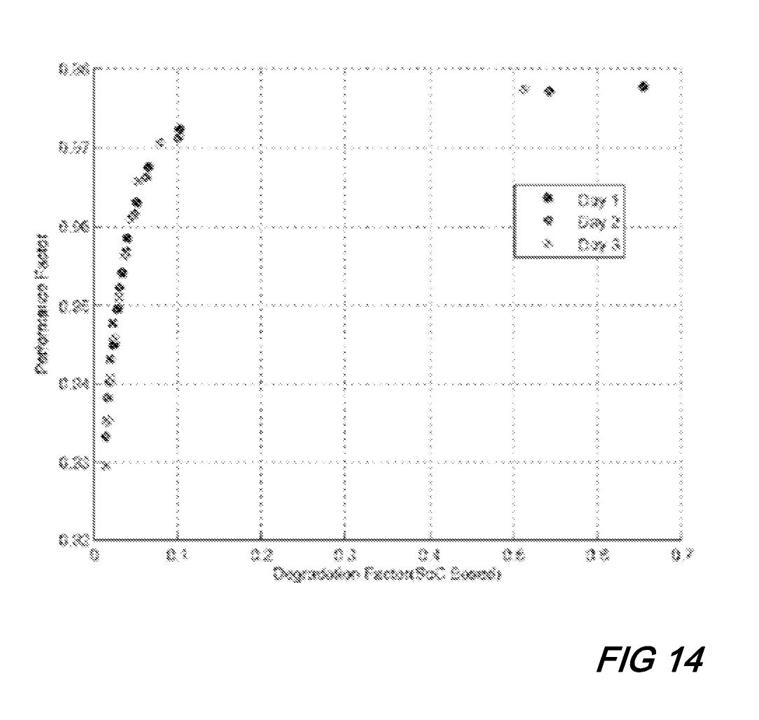

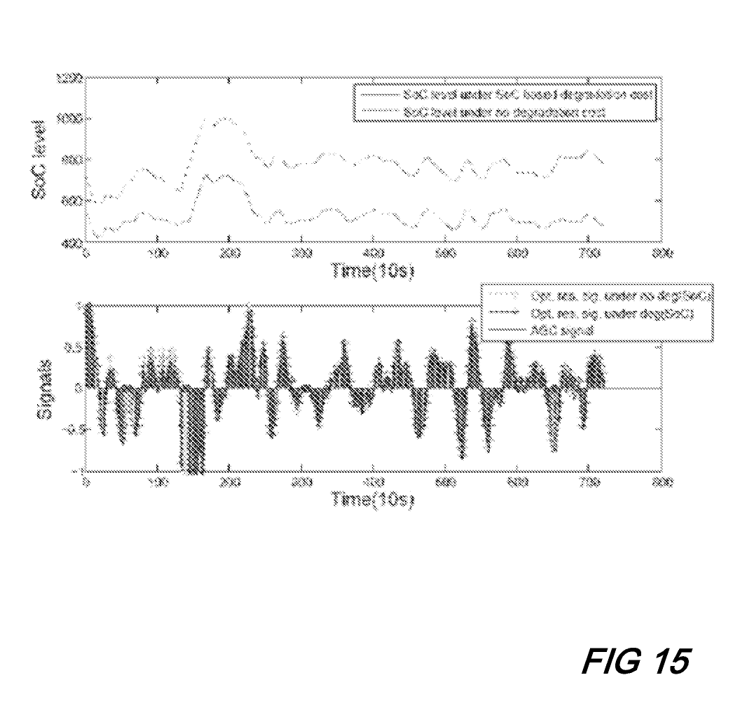

The preliminary results from SoC based degradation problem formulation include the trade-off curve shown in FIG. 13 and SoC and response signal trajectories shown in FIG. 14. and FIG. 15. The trade-off curve is rather uninteresting as performance factor is not very sensitive to a large range of values of weight on instant degradation cost. This is due—in part—to the fact that SoC transition is not very drastic in a particular time interval so as to influence the instantaneous energy throughput significantly and thereby performance factor which is a linear function of energy throughput. However, the SoC level is increasingly tightened around the reference SoC level as more weight is given to instantaneous degradation cost. The reference SoC of 0.5 is chosen in this problem.

At this point, while we have presented this disclosure using some specific examples, those skilled in the art will recognize that our teachings are not so limited. Accordingly, this disclosure should be only limited by the scope of the claims attached hereto.

1. An improved control structure for operating in a frequency regulating market and connected to a power grid, said control structure comprising:
an advanced controller running an intelligent power management algorithm;
an advanced hardware architecture including a battery and an ultra-capacitor;
wherein in response to receiving an indication of a required power output P_{ESS}*(t) transmitted from the frequency regulating market, the power management controller determines an amount of power to be contributed by the battery and an amount of power to be contributed by the ultra-capacitor to provide the required power output according to the following relationship:
P_{ESS}*(t)=P_{Batt}*+P_{UC}*
wherein P_{Batt}* is the amount of power contributed by the battery and P_{UC}* is the amount of power contributed by the ultra-capacitor.

2. The HESS of claim 1 wherein said intelligent controller is one selected from the group consisting of: a fuzzy logic controller, a model predicative controller, a particle swarm optimization controller and a genetic controller.

3. The HESS of claim 1 wherein the intelligent controller is a fuzzy logic controller which receives as input(s) the required power signal P_{ESS}*(t), a State of Charge (SOC) of the battery a SOC_{Batt} signal, and a State of Charge (SOC) of the ultra-capacitor a SOC_{UC} signal and generates as output a battery power command P_{Batt}* and an ultra-capacitor power command P_{UC}* indicative of the amount of power to be contributed by the battery and ultra-capacitor respectively.

4. The HESS of claim 1 further comprising a DC/DC converter and a DC/AC inverter, an output of the UC being connected to an input of the DC/DC converter, an output of the DC/DC converter being connected to the battery, an output of the battery being connected to an input of the DC/AC inverter, an AC output of the inverter being connected to the power grid.

5. The HESS of claim 1 further comprising a first and second DC/DC converter and a DC/AC inverter, an output of the UC being connected to an input of the first DC/DC converter, an output of the battery being connected to an input of the second DC/DC converter, and an output of the first DC/DC converter and an output of the second DC/DC converter being connected to an input of the DC/AC inverter, an AC output of the inverter being connected to the power grid.

6. The HESS of claim 1 further comprising a first and second DC/AC inverter and a DC/DC converter, an output of the UC being connected to an input of the DC/DC converter, an output of the battery being connected to an input of the second DC/AC inverter, and an output of the DC/DC converter being connected to an input of the first DC/AC inverter, the outputs of the first and second DC/AC inverters being connected together and the combined AC output of the inverters being connected to the power grid.

7. The HESS of claim 1 further comprising a modular multilevel converter having at least two DC inputs and an AC output, an output of the UC being connected to the first input of the modular multilevel converter, an output of the battery being connected to the second input of the modular multilevel converter, the AC output of the modular multilevel converter being connected to the power grid.
